(19) United States
(12) Patent Application Publication
(10) Pub. No.: US 2021/0269635 A1
(43) Pub. Date: Sep. 2, 2021

(54) EPOXY RESIN COMPOSITIONS, PREPREG, AND FIBER-REINFORCED COMPOSITE MATERIALS

(71) Applicant: Toray Industries, Inc., Tokyo (JP)

(72) Inventors: Swezin Than Tun, Tacoma, WA (US); Jonathan Hughes, Tacoma, WA (US); Nobuyuki Arai, Tacoma, WA (US)

(73) Assignee: Toray Industries, Inc., Tokyo (JP)

(21) Appl. No.: 17/276,623

(22) PCT Filed: Sep. 20, 2019
(86) PCT No.: PCT/IB2019/001051

§ 371 Date: Mar. 16, 2021

Related U.S. Application Data
(60) Provisional application No. 62/734,541, filed on Sep. 21, 2018.
(60) Provisional application No. 62/897,633, filed on Sep. 9, 2019.

(51) Int. Cl. C08L 63/00

(52) U.S. Cl. CPC C08L 63/00; C08L 2205/025; C08L 2205/03

(57) ABSTRACT

This invention relates to an epoxy resin composition for fiber-reinforced composite materials, which contains the following constituent components (A), (B), and (C). Component (A) contains at least one poly-naphthalene-based epoxy resin, component (B) contains at least one alicyclic epoxy resin and/or a divinylarene diepoxide resin, and component (C) contains at least one amine curing agent. This epoxy resin composition, containing a specific combination of particular types of epoxy resin and curatives, provides high heat resistance and high flexural modulus under extreme environmental conditions. More particularly, a cured resin prepared by the epoxy resin composition offers well balanced mechanical properties that are suitable for preparing fiber-reinforced composite materials useful in aircraft components, spacecraft components, automobile components, artificial satellites components, industrial components, and the like.

### CROSS-REFERENCE TO RELATED APPLICATIONS

This is the U.S. National Phase application of PCT/IB2019/001051, filed Sep. 20, 2019, which claims priority to U.S. Provisional Application No. 62/734,541, filed Sep. 21, 2018, and to U.S. Provisional Application No. 62/897,633, filed Sep. 9, 2019, the disclosures of each of these applications being incorporated herein by reference in their entireties for all purposes.

### FIELD OF THE INVENTION

The present application provides an epoxy resin composition for fiber-reinforced composite materials that are well-suited for aerospace applications, sports applications, and general industrial applications.

### BACKGROUND OF THE INVENTION

Fiber-reinforced composite (FRC) materials comprising a reinforced fiber and a matrix resin have excellent mechanical properties such as strength and rigidity while being lightweight, and therefore are widely used as aircraft members, spacecraft members, automobile members, railway car members, ship members, sports apparatus members, and electronic members such as computer housings for laptops.

Thermosetting resins or thermoplastic resins are employed as the matrix resin for fiber-reinforced composite materials, but thermosetting resins are largely used due to their ease of processing. Amongst these, epoxy resins, which provide outstanding characteristics such as high heat resistance, high elastic modulus, relative toughness, low shrinkage on curing, and high chemical resistance, are most often employed. As epoxy resin curing agents, there are used amines, polyamines, anhydrides, imidazole derivatives, and the like. Polyamines have a long history of usage for their excellent bonding properties and superior performance and therefore have been widely used as curing agents for the epoxy resin compositions for fiber-reinforced composite materials. The reinforcement fibers may be in the form of woven cloth or continuous filaments. These fiber-reinforced composite materials can be produced by using filament winding methods, prepreg lamination methods, molding methods, pultrusion methods or the like. Among these methods, the prepreg lamination method is predominantly used to obtain high performance composite materials. Prepreg lamination is a method in which a prepreg or prepregs produced by impregnating a reinforcing fiber with a thermosetting resin composition is or are formed and laminated, followed by curing of the thermosetting resin composition through the application of heat and pressure to obtain the fiber-reinforced composite material.

As the fiber-reinforced compositions are used in the prepreg, the performance of the materials is typically measured in term of mechanical properties, chemical and heat resistance, thermal stability, handling and processability, and the like. The mechanical properties depend on both the reinforcement fiber and the matrix resin. The important design properties include tensile strength and modulus, compression strength and modulus, impact resistance, damage tolerance, and toughness. In general, the fiber-reinforced composite materials are composed of about 55% by weight of the reinforcing fibers, which govern the majority of the properties, whereas the matrix resin has greatest effect on compression strength and transverse tensile properties. Although existing fiber-reinforced composite materials are well-suited for their intended use in providing high strength and toughness, there still is a continuous need for materials that have even higher levels of compression strength under different environmental conditions, more particularly at service temperatures above 120° C.

State-of-the-art epoxy matrix resin systems in high performance composites are typically based on N,N,N′,N′-tetraglycidyl 4,4′-diaminodiphenyl methane and 4,4′-diaminodiphenyl sulfone, the combination of which produces high tensile strength and compression moduli. However, this type of epoxy resin composite has large amounts of water absorption, resulting in the hot/wet properties being impaired, particularly when tested above a temperature of 120° C.

Epoxy resins such as dicyclopentadiene-based epoxy resins, naphthalene-based epoxy resins, and some phenol novolac epoxy resins can effectively reduce the water absorption. As disclosed in U.S. Pat. No. 5,312,878, an epoxy resin system using a naphthalene-based epoxy resin with a dicyclopentadiene-modified phenolic as a curing agent provides higher heat resistance, low water absorption, and good adhesion. Additionally, as disclosed in Pat. Pub. Nos. PH 10330513 and WO 2017038880, an epoxy resin composition using dicyclopentadiene-based epoxy resin or naphthalene-based epoxy resin respectively with an amine curing agent provides excellent water resistance, good drapability/moldability, and high hot/wet performance. However, the fiber-reinforced composite performance of these epoxy resin compositions under hot/wet conditions tested above 120° C. showed a huge reduction in mechanical properties.

The use of solid type epoxy resin containing more than two epoxy functional groups per molecule provides a high level of heat resistance, but such formulations have a higher viscosity and are difficult to process. Thus, liquid epoxy resin has been used to control the processing viscosity. As disclosed in Pat. Pub. Nos. US 20030064228 and WO 2017033056, an epoxy resin composition which uses an alicyclic epoxy with an amine curing agent provides excellent high resistance and hot/wet performance, and has a viscosity which is suitable for resin transfer molding. However, these epoxy resin compositions include a large amount of liquid epoxy resin resulting in a huge reduction in hot/wet performance tested above 120° C. Additionally, the forming of rigid crosslinking structures adversely affects the flexural elongation, which is unfavorable to the fracture toughness. In a further development disclosed in U.S. Pat. No. 9,617,413, an epoxy resin composition using a divinylarene dioxide epoxy resin and solid novolac epoxy resin with an amine curing agent provides high heat resistance, high char yield, and good solvent resistance. However, the fiber-reinforced composite performance of these epoxy resin compositions under hot/wet conditions tested above 120° C. also showed a huge reduction in mechanical properties.

Therefore, the present invention seeks to provide an epoxy resin composition that when cured has well balanced properties with respect to resin modulus, flexural strength, and heat resistance. Another object is to provide a fiber-reinforced composite material that is excellent in performance under hot/wet conditions tested above 120° C., in particular temperatures above 150° C. It also offers an epoxy resin composition for fiber-reinforced composite materials which is suitable for use in impregnating reinforcing fibers; more particularly, the present invention offers an epoxy resin composition for fiber-reinforced composite materials where the cured material obtained by heating has a high level of heat resistance and hence is suitable for use as aircraft components and the like.

### SUMMARY OF THE INVENTION

As a result of the extensive research in view of the difficulties described above, the inventors have discovered that the aforementioned problems are resolved by employing, in fiber-reinforced composite material applications, an epoxy resin composition formed by mixing at least one poly-naphthalene-based epoxy resin, one or more of liquid epoxy resins having a viscosity of less than 1 Pa·s at 25° (in particular, at least one alicyclic epoxy resin and/or at least one divinylarene dioxide epoxy resin), and at least one amine curing agent.

This invention according to exemplary embodiments relates to an epoxy resin composition for a fiber-reinforced composite material, which comprises, consists essentially of, or consists of the following constituent components (A), (B), (C), (D), and (E), wherein components (D) and (E) are optional:
(A) at least one poly-naphthalene-based epoxy resin;
(B) at least one liquid epoxy resin having a viscosity of less than 1 Pa·s at 25° C.;
(C) at least one amine curing agent;
(D) optionally, at least one onium salt catalyst; and
(E) optionally, at least one glycidyl ether epoxy resin or glycidyl amine epoxy resin with two or more epoxy groups per molecule.

In one embodiment, component (A) of the epoxy resin composition comprises at least one epoxy resin containing two or more naphthalene moieties per molecule with two or more epoxy functionalities (epoxy groups) per molecule (referred to herein as a “poly-naphthalene-based epoxy resin”). The amount of poly-naphthalene-based epoxy resin may, in one embodiment, be 20 to 60 PHR (parts per hundred resin) of the total epoxy resin in the epoxy resin composition.

In one embodiment, component (B) of the epoxy resin composition comprises at least one alicyclic epoxy resin with two or more epoxy functionalities per molecule. In another embodiment, component (B) comprises at least one divinylarene dioxide containing two or more epoxy functionalities per molecule.

In one embodiment, component (C) of the epoxy resin composition comprises at least one aromatic polyamine, such as a diaminodiphenylsulfone. As used herein, the term “aromatic polyamine” means a compound that contains at least one aromatic moiety (such as a benzene ring) and two or more amino groups that are primary or secondary amino groups. As used herein, the term “aromatic amine” means a compound that contains at least one aromatic moiety (such as a benzene ring) and at least one amino group which is a primary or secondary amino group.

In some embodiments, optional component (D) of the epoxy resin composition may comprise at least one onium salt catalyst. The onium salt catalyst may be represented by Formula (III):

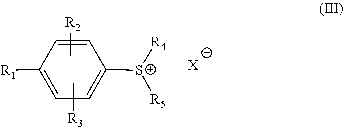

wherein R₁ represents a hydrogen atom, a hydroxyl group, an alkoxyl group, or a group represented by Formula (IV):

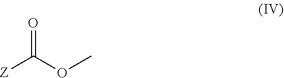

wherein Z represents an alkyl group, an alkoxyl group, a phenyl group or a phenoxy group, all of which may have one or more substituents, each of R₂ and R₃ independently represents a hydrogen atom, a halogen atom, or an alkyl group, each of R₄ and R₅ independently represents an alkyl group, an aralkyl group or an aryl group, each of which may have one or more substituents, and X⁻ represents SbF₆⁻, PF₆⁻AsF₆⁻, or BF₄⁻.

In some embodiments, optional component (E) of epoxy resin composition may comprise at least one glycidyl ether epoxy resin or glycidyl amine epoxy resin (not corresponding to component (A) or (B), i.e., not a poly-naphthalene-based epoxy resin or a liquid epoxy resin having a viscosity of less than 1 Pa·s at 25° with at least two or more epoxy functionalities per molecule. In further embodiments of the invention, the epoxy resin composition may additionally comprise at least one thermoplastic resin, such as a polyethersulfone.

Therefore, the present invention seeks to provide an epoxy resin composition that has, when cured, well balanced properties between resin modulus, flexural strength, and heat resistance. Another advantage over epoxy resin compositions described in the prior art is that the fiber-reinforced composite material prepared using the inventive epoxy resin composition has excellent performance under hot/wet conditions tested above 120° C. It has been surprisingly found that even a small amount of alicyclic epoxy resin and/or divinylarene dioxide epoxy resin or other liquid epoxy resin having a viscosity of less than 1 Pa·s at 25° C. in combination with a poly-naphthalene-based epoxy resin having at least two naphthalene moieties per molecule and at least two glycidyl ether groups per molecule and an amine curing agent (especially an aromatic polyamine curing agent) provides an epoxy resin composition that, when cured, exhibits excellent heat resistance, flexural modulus, flexural strength, and low water absorption. In some embodiments, a catalyst and glycidyl amine epoxy resin and/or glycidyl ether epoxy resin may be used to accelerate the cure of the epoxy resin composition and to improve the handleability.

The present invention also provides a prepreg comprising carbon fibers impregnated with an epoxy resin composition in accordance with any of the above-mentioned embodiments as well as a carbon fiber-reinforced composite material obtained by curing such a prepreg. Further embodiments of the invention provide a carbon fiber-reinforced composite material comprising a cured resin product obtained by curing a mixture comprised of an epoxy resin composition in accordance with any of the above-mentioned embodiments and carbon fibers. This epoxy resin composition is useful in the molding of fiber-reinforced composite materials. More particularly, the present invention makes it possible to provide an epoxy resin composition for a fiber-reinforced composite material where the cured material obtained by heating has a high-level heat resistance and strength properties. In the field of this invention, a material having a high level of heat resistance is defined as a material having a hot/wet glass transition temperature of above 200° C. and good mechanical properties at or close to a temperature of 150° C.

### DETAILED DESCRIPTION OF EMBODIMENTS OF THE INVENTION

In the epoxy resin composition according to embodiments of the present invention, component (A) comprises one or more epoxy resins containing at least two naphthalene moieties per molecule and at least one glycidyl ether group per molecule. Such epoxy resins are referred to herein as “poly-naphthalene-based epoxy resins.” The term “naphthalene” as used herein describes a structure of two benzene rings which are conjugated (or fused) to each other directly. Any of the poly-naphthalene-based monomer precursors (such as a hydroxyl-substituted poly-naphthalene) may be formed into a suitable poly-naphthalene-based epoxy resin. The glycidyl ether groups may be formed by reacting the precursor with epichlorohydrin in the presence of a basic catalyst.

Without wishing to be bound by theory, it is believed that the poly-naphthalene-based epoxy resins, which form part of an epoxy resin composition as described herein, provide low water absorption, high flexural modulus, and high heat resistance once the epoxy resin composition has been cured. Abovementioned component (A) is an essential component for an epoxy resin composition to successfully provide excellent performance, particularly under hot/wet conditions.

The poly-naphthalene-based epoxy resin may comprise one poly-naphthalene moiety to which at least one glycidyl ether substituent is bonded. More than one glycidyl ether substituent may be bonded to the poly-naphthalene moiety at any suitable position in any suitable combination. The poly-naphthalene moiety may also have a non-glycidyl ether substituent bonded at any of the non-glycidyl ether substituted sites of any of the naphthalene rings. Suitable non-glycidyl ether substituent groups include, without limitation, hydrogen atom, halogen atoms, C1 to C6 alkyl groups, C1 to C6 alkoxyl groups, C1 to C6 fluoroalkyl groups, cycloalkyl groups, aryl groups, and aryloxyl groups and combinations thereof. Such non-glycidyl ether substituent groups may be straight, branched, cyclic, or polycyclic substituents, wherein these groups are optionally employed individually or different groups are optionally employed in combination thereof.

The poly-naphthalene-based epoxy resin may contain two, three, four or more naphthalene rings linked to each other either directly or through a linking (bridging) moiety, such as a methylene group (—CH₂—), with at least one glycidyl ether group (preferably at least two glycidyl ether groups) being bonded to (substituted on) a naphthalene ring (or multiple naphthalene rings, where two or more glycidyl ether groups are present). The multiple naphthalene rings may optionally be substituted with one or more further substituents, including any of the aforementioned types of substituents. Thus, in various embodiments of the invention component (A) may be comprised of one or more poly-naphthalene-based epoxy resins represented by the following Formula (V):

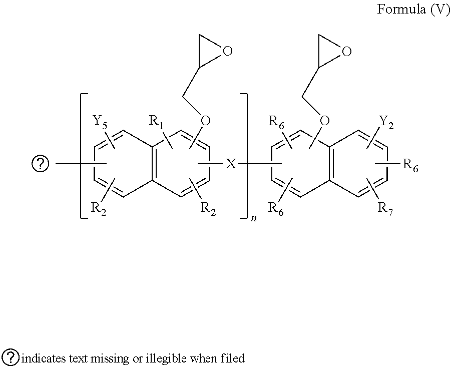

wherein n represents the number of repeating units and is an integer of 1 or more (e.g., an integer of 1 to 5); R₁ to R₈ are each independently selected from the group consisting of a hydrogen atom, halogen atoms, C1 to C6 alkyl groups, C1 to C6 alkoxyl groups, C1 to C6 fluoroalkyl groups, cycloalkyl groups, aryl groups, and aryloxyl groups (these groups are optionally employed individually or different groups are optionally employed in combination as each of R₁ to R₈); Y₁ and Y₂ are each independently selected from the group consisting of a hydrogen atom and a glycidyl ether group; and each X is independently selected from the group consisting of a direct bond, —CH2—, —C(CH₃)₂—, —S—, —SO₂—, —O—, —C(═O)O—, —C(═O)NH—, C1 to C6 alkyl groups, C1 to C6 alkoxyl groups, cycloalkyl groups, aryl groups and aryloxyl groups (these groups are optionally employed individually or different groups are optionally employed in combination as X).

In another embodiment, component (A) may be comprised of one or more epoxy resins represented by the following Formula (VI):

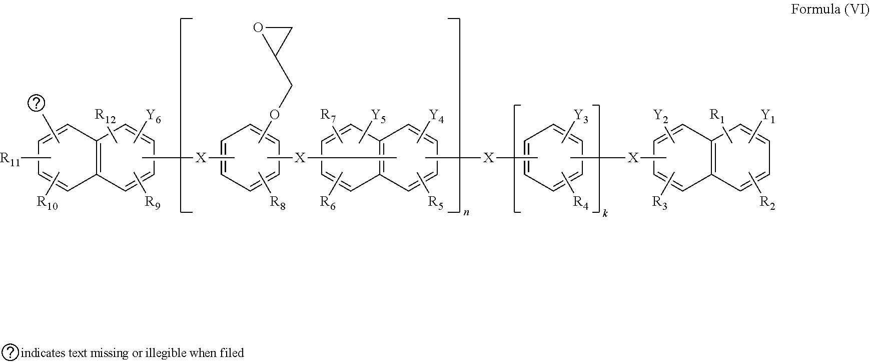

wherein R₁ to R₁₂ are each independently selected from the group consisting of hydrogen atoms, halogen atoms, C1 to C10 alkyl groups, C1 to C10 alkoxyl groups, C1 to C10 fluoroalkyl groups, cycloalkyl groups, aryl groups, aryloxyl groups, and glycidoxy groups, Y₁ to Y₇ are each independently selected from the group consisting of hydrogen atoms, halogen atoms, C1 to C10 alkyl groups, C1 to C10 alkoxyl groups, C1 to C10 fluoroalkyl groups, cycloalkyl groups, aryl groups, aryloxyl groups, and glycidoxy groups, wherein each benzene nucleus may be substituted with one or more Y groups, n is 0 or an integer of 1 to 5, k is 0 or an integer of 1 to 3, wherein the Y groups may be attached to either or both rings of each naphthalene nucleus; and each X is independently selected from the group consisting of a direct bond, —CH₂—, —C(CH₃)₂—, —S—, —SO₂—, —O—, —C(═O)O—, —C(═O)—, —C(═O)NH—, C1 to C6 alkylene groups, C1 to C6 alkoxylene groups, cycloalkylene groups, arylene groups and aryloxylene groups (these groups are optionally employed individually or different groups are optionally employed in combination as X).

The glycidyl ether group or groups on the naphthalene moieties may be bonded to any of the carbon atoms of each naphthalene ring in any combination. The glycidyl ether groups may therefore be present at the 2, 3, 4, 5, 6, and/or 7 positions of any of the naphthalene rings present, and, where there is more than one glycidyl ether group, may be present in any suitable combination on any of the naphthalene rings of the epoxy resin.

Specific precursors which may be used for producing the poly-naphthalene-based epoxy resin having two or more naphthalene moieties per molecule, by way of example, include 1-(2-hydroxy-naphthalen-1-ylmethyl)-naphthalene-2-ol, 1-(2-hydroxy-naphthalen-1-ylmethyl)-naphthalene-2,7-diol, 1-(2-hydroxy-naphthalen-1-ylmethyl)-naphthalene-7-ol, 1-(7-hydroxy-naphthalen-1-ylmethyl)-naphthalene-7-ol, 1-(2,7-dihydroxy-naphthalen-1-ylmethyl)-naphthalene-2,7-diol, or any combination thereof. Such precursors may be reacted with epichlorohydrin, using base catalysis, to introduce the desired glycidyl ether groups as a result of the hydroxyl groups of the precursor reacting with the epichlorohydrin.

The chemical structures of specific exemplary (non-limiting) poly-naphthalene-based epoxy resins suitable for use in the present invention are shown below. The epoxy equivalent weight (EEW) of the component (A) useful in embodiments of the present invention is preferably greater than 150 g/eq.

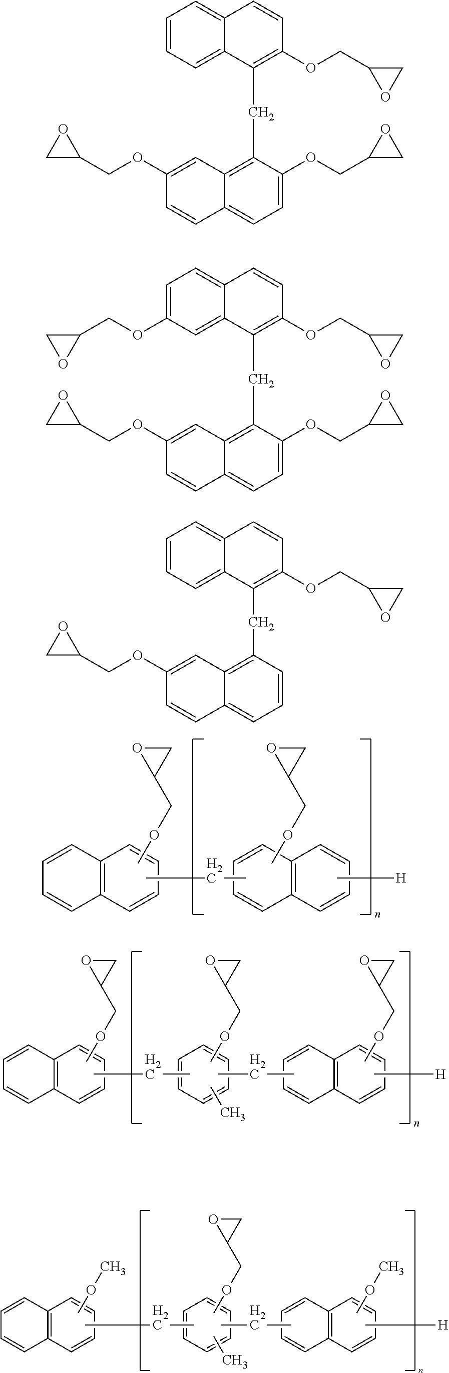

where n is the number of repeating units and an integer of 1 or more (e.g., an integer of 1 to 5).

Examples of commercially available products suitable for use as component (A) include “Epiclon (registered trademark)” HP4700, HP4710, HP4770, HP5000, EXA4701, EXA4750, and EXA7240 (manufactured by DIC Co., Ltd.), NC-7000 and NC-7300 (manufactured by Nippon Kayaku Co., Ltd.) and ESN-175 and ESN-375 (manufactured by Tohto Kasei Epoxy Co., Ltd.), etc., as well as combinations thereof.

The amount of component (A) may be in the range of 20 to 60 PHR (parts per hundred resin) of total epoxy resin in the epoxy resin composition. In certain embodiments, the amount of poly-naphthalene-based epoxy resin may be in the range of 25 to 45 PHR or 30 to 40 PHR of total epoxy resin. If the amount is greater than 20 PHR, water absorption in the cured epoxy resin composition will be low and hot/wet flexural modulus will be high. If the amount is less than 60 PHR, the resin viscosity is kept low enough to improve handling and processing of the fiber-reinforced composite (FRC) material.

In accordance with embodiments of the invention, the epoxy resin composition further comprises the component (B) wherein the component (B) comprises an epoxy resin or more than one epoxy resin which is or are different from the poly-naphthalene-based epoxy resin of component (A) which is or are liquid and which has or have a viscosity of less than 1 Pa·s at 25° C. Preferably, such epoxy resins contain two or more epoxy groups per molecule. In particular, component (B) may comprise component (B1) or/and component (B2) which are epoxy resins different from each other, wherein component

(B1) comprises at least one alicyclic epoxy resin (a compound containing at least one aliphatic ring and at least two epoxy groups per molecule) and component (B2) comprises at least one divinylarene dioxide (a compound having an aromatic nucleus to which are directly attached at least two epoxy groups (vinyl oxide groups)). Without wishing to be bound by theory, it is believed that the component (B) provides an epoxy resin composition which, when cured, has high cross linking and high heat resistance, and which in its uncured state is a low viscosity resin for handleability and tackiness. “Handleability” refers to the ability to easily handle and process an epoxy resin composition.

In one embodiment, component (B1) comprises at least one alicyclic epoxy resin represented by Formula (I):

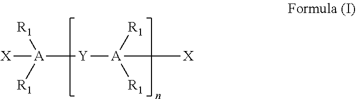

wherein n is the number of repeating units and an integer of 0 or 1; each A is a cycloaliphatic group independently selected from the group consisting of cycloalkyl groups and cycloalkenyl groups having 4 to 8 carbon atoms (wherein these groups are optionally employed individually or different groups are optionally employed in combination as each of A); each X is independently selected from the group consisting of a hydrogen atom and an oxygen atom attached to adjacent carbon atoms of a cycloaliphatic group to form an epoxy group (as in, for example, bis(2,3-epoxycyclopentyl)ether); Y is independently selected from the group consisting of a direct bond, —SO₂—, —C(═O)O—, —C(═O)—, —O—, —C(═O)NH—, C1 to C6 alkyl groups (e.g., —(CH₂)ₘ—, wherein m is an integer of 1 to 6, for example), C1 to C6 alkoxyl groups, cycloalkyl groups, dicarboxylate and aryloxyl groups (wherein these groups are optionally employed individually or different groups are optionally employed in combination as Y); each R₁ is independently selected from the group consisting of a hydrogen atom, a vinyl oxide group, a glycidyl group, a glycidyl ether group, a glycidyl ester group, C1 to C7 cycloalkyl groups directly attached to at least one of the A groups (thereby forming a fused ring structure, as in dicyclopentadiene diepoxide for example).

Suitable cycloaliphatic groups which may be present as A in Formula (I) include cycloalkyl and cycloalkenyl groups containing from 4 to 8 carbon atoms in an aliphatic ring, such as cyclobutyl, cyclopentyl, cyclohexyl, cycloheptyl and cyclooctyl. Accordingly, A may be a four- to eight-membered aliphatic ring. Preferably, the cycloaliphatic group is saturated (i.e., a cycloalkyl group), but in other embodiments can be unsaturated (i.e., a cycloalkenyl group containing one or more carbon-carbon double bonds). Where n=1, the A groups may be the same as or different from each other.

A vinyl oxide group has the following base structure:

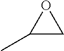

A glycidyl group has the following base structure:

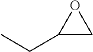

A glycidyl ether group has the following base structure:

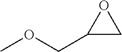

A glycidyl ester group has the following base structure:

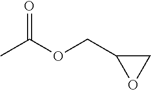

Hydrogen atoms on one or more carbon atoms in the above base structures may be substituted by other substituents such as alkyl groups (e.g., a methyl group).

In some embodiments, component (B1) comprises at least one 1,2-epoxycycloalkane represented by the following Formula (VII):

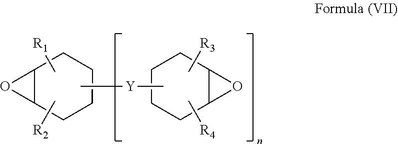

wherein n is the number of repeating units and an integer of 0 or 1; Y is independently selected from the group consisting of a direct bond, —SO₂—, —C(═O)O—, —C(═O)—, —O—, —C(═O)NH—, C₁ to C₆ alkyl groups, C₁ to C₆ alkoxyl groups, cycloalkyl groups, aryl groups, and aryloxyl groups (wherein these groups are optionally employed individually or different groups are optionally employed in combination as Y, such as in bis(3,4-epoxycyclohexylmethyl) adipate); and R₁-R₄ are independently selected from the group consisting of a hydrogen atom, a glycidyl group, a glycidyl ether group, and a glycidyl ester group (wherein these groups are optionally employed individually or different groups are optionally employed in combination as each of R₁-R₄), subject to the proviso that the 1,2-epoxycycloalkane contains at least two epoxy groups per molecule (according to one embodiment, a total of two epoxy groups per molecule).

Examples of suitable alicyclic epoxy resins useful as component (B1) are vinylcyclohexene diepoxide, 3′,4′-epoxycyclohexylmethyl 3,4-epoxycyclohexanecarboxylate, bis(2,3-epoxypropyl) cyclohex-4-ene-1,2-dicarboxylate, diglycidyl 1,2-cyclohexanedicarboxylate, bis(3,4-epoxycyclohexylmethyl) adipate, dicyclopentadiene diepoxide, dipentene dioxide, 1,4-cyclooctadiene diepoxide, bis(2,3-epoxy cyclopentyl)ether and the like. Examples of commercially available products suitable for use as component (B1) include “Celloxide (registered trademark)” 2021P (manufactured by Daicel Chemical Industries), “Araldite (registered trademark)” CY179, CY184, and CY192 (manufactured by Huntsman Advanced Materials), “Epotec (registered trademark)” YDH184 (manufactured by Aditya Birla Chemicals), etc. as well as combinations thereof.

In one embodiment, component (B2) comprises at least one divinylarene dioxide (a compound having two vinyl groups attached to an arene nucleus in which the vinyl groups have been converted to epoxy groups, by epoxidation for example). The component (B2) may comprise, for example, any substituted or unsubstituted arene nucleus bearing one or more epoxidized vinyl (vinyl oxide) groups in any ring position. For example, the arene portion of the divinylarene dioxide may consist of an unsubstituted benzene (wherein “unsubstituted” in this context means that the benzene nucleus is not substituted with any substituents other than hydrogen and epoxidized vinyl groups), a substituted benzene, a (substituted) ring-annulated benzene or a homologously bonded (substituted) benzene, or a combination thereof. The divinylbenzene portion of the divinylarene dioxide may be ortho, meta, or para isomers or any mixture thereof (that is, the vinyl oxide groups substituted on the benzene nucleus may be ortho, meta or para to each other). Additional substituents may consist of H₂0₂-resistant groups including, for example, a saturated alkyl group or an aryl group each individually having from 1 to about 20 carbon atoms, a halogen, a nitro, an isocyanate, or an RO-group wherein R may be a saturated alkyl or an aryl each individually having from 1 to about 20 carbon atoms. Ring-annulated benzenes may include, for example, naphthalene, tetrahydronaphthalene, and the like. Homologously bonded (substituted) benzenes may include, for example, biphenyl, diphenylether, and the like.

The divinylarene dioxide used in various embodiments of the present invention may have any of the chemical structures as follows:

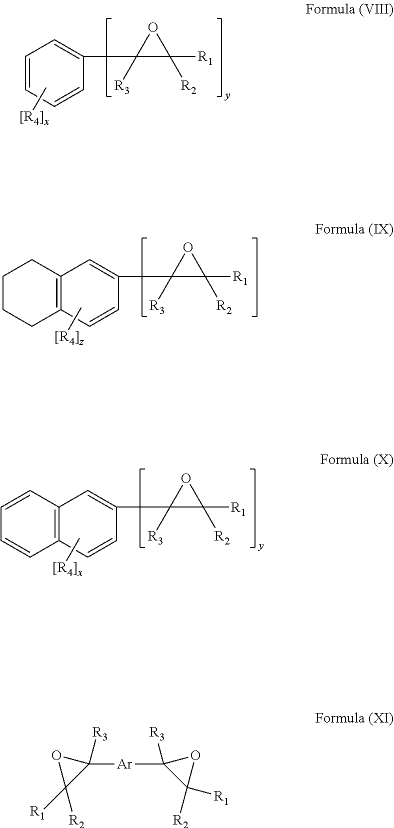

In the above Formulae (VIII)-(XI) of the divinylarene dioxide, each R₁, R_{2,} R₃ and R₄ individually may be (i.e., R₁, R_{2,} R₃ and R₄ are the same or different and are independently selected from) hydrogen, an alkyl, a cycloalkyl, an aryl, or an aralkyl group;

or a H₂O₂-resistant group including for example a halogen, a nitro, an isocyanate, or an RO group, wherein R may be an alkyl group, an aryl group or an aralkyl group ; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, a 1,3-phenylene group, provided that the divinylarene dioxide contains at least two epoxy groups per molecule. In addition, R₄ can be a reactive group(s) including for example an epoxide, an isocyanate, or any other reactive group; and Z can be an integer from 0 to 6 depending on the substitution pattern. According to certain embodiments, each of R₁, R_{2,} R₃ and R₄ is hydrogen.

In certain embodiments, the divinylarene dioxide may comprise, for example, a divinylbenzene dioxide, a divinylnaphthalene dioxide, a divinylbiphenyl dioxide, a divinyldiphenylether dioxide, or mixtures thereof.

In other embodiments, the divinylarene dioxide may be, for example, a divinylbenzene dioxide (DVBDO). For example, a divinylbenzene dioxide may include a divinylbenzene dioxide as illustrated by the following Formula (XII):

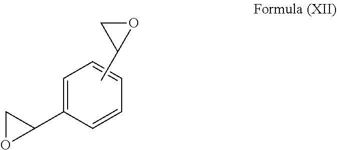

Divinylarene dioxides, particularly those derived from divinylbenzene such as, for example, DVBDO, are a class of diepoxides which have a relatively low liquid viscosity but (when cured) a higher rigidity and crosslink density than conventional epoxy resins.

Formulae (XIII) and (XIV) below illustrate embodiments of preferred chemical structures of the DVBDO:

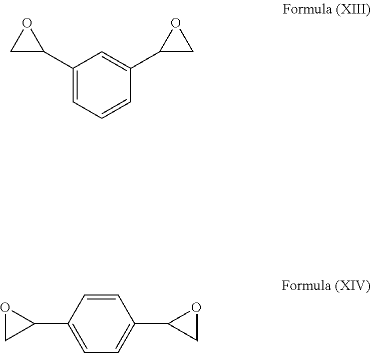 [SMILES: c1cc(C2CO2)cc(C2CO2)c1 ; c1cc(C2CO2)ccc1C1CO1]

When DVBDO is prepared by the processes known in the art, it may be possible to obtain one of three possible isomers: ortho, meta, and para. Accordingly, a DVBDO illustrated by any one of the above Formulae individually or as a combination thereof is suitable for use in embodiments of the present invention. Formulae (XIII) and (XIV) above show the meta (1,3-DVBDO) and para (1,4-DVBDO) isomers of DVBDO, respectively. The ortho isomer is rare; usually, DVBDO is mostly produced generally as a mixture having a ratio of meta (Formula (XIII)) to para (Formula (XIV)) isomers in a range of from about 9:1 to about 1:9.

Like glycidyl ether and glycidyl amine epoxy resins, divinylarene dioxide epoxy resins also react well with polyamines. This can allow the desirable reaction of the amine with the epoxy structure of the divinylarene dioxide epoxy resin, resulting in molecular motion of the resulting polymer chain being restricted and the heat resistance and modulus of elasticity of the cured material obtained are raised.

The amount of component (B1) may comprise up to 15 PHR of total epoxy resin in the epoxy resin composition. In certain embodiments, the amount of component (B1) may be in the range of 3 to 13 PHR or 5 to 10 PHR of total epoxy resin in the epoxy resin composition. If the amount is greater than 3 PHR, the resin modulus will be increased and the hot/wet performance of the FRC material will be improved. If the amount of component (B1) is less than 15 PHR, the heat resistance will be high. The amount of component (B2) may comprise 40 PHR of total epoxy resin in the epoxy resin composition. In certain embodiments, the amount of component (B2) may be in the range of 5 to 30 PHR or 10 to 20 PHR of total epoxy resin. If the amount of component (B2) is greater than 5 PHR, the resin modulus will be increased and the hot/wet performance of the FRC material will be improved. If the amount is less than 40 PHR, the flexural elongation will be good and the thermal stability of the cured epoxy resin composition will be adequate. In other embodiments, component (B) may comprise a combination of component (B1) and component (B2). The ratio of the component (B1) and the component (B2) may be in the range from 0:40 to 15:0 PHR (for example, 1:39 to 14:1 PHR) of total epoxy resin.

In accordance with embodiments of the invention, the epoxy resin composition also comprises a component (C) which is comprised of one or more amine curing agents. The amine curing agent is a compound that contains at least one nitrogen atom in the molecule (i.e., it is an amine curing agent) and is capable of reacting with epoxy groups in the epoxy resins for curing. The amine curing agent preferably contains one, two, three, four or more active hydrogens per molecule. The nitrogen atom(s) may be in the form of primary and/or secondary amino groups. Without wishing to be bound by theory, it is believed that the amine curing agents utilized in the present invention assist in providing a cured epoxy resin composition having high heat resistance and storage stability.

As previously mentioned, component (C) comprises at least one amine curing agent, preferably an aromatic amine curing agent or an aromatic polyamine curing agent. One suitable type of amine curing agent for component (C) is a diaminodiphenyl sulfone, which is an example of an aromatic polyamine curing agent. Specific illustrative examples of suitable diaminodiphenyl sulfones include, but are not limited to, 4,4′-diaminodiphenyl sulfone (4,4′-DDS) and 3,3′-diaminodiphenyl sulfone (3,3′-DDS) and combinations thereof. In certain embodiments of the invention, component (C) consists essentially of or consists of one or more diaminodiphenyl sulfones. In such embodiments, diaminodiphenyl sulfone is the only type of curing agent present in the epoxy resin composition or constitutes at least 90%, at least 95%, or at least 99% by weight of the entire amount of curing agent. These curing agents may be supplied as a powder and may be employed in the form of a mixture with a liquid epoxy resin composition.

Examples of commercially available aromatic polyamine products suitable for use as component (C) are “Aradur (registered trademark)” 9664-1 and 9791-1 (manufactured by Huntsman Advanced Materials).

In other embodiments, any one or more curing agents other than, or in addition to, the abovementioned diaminodiphenyl sulfone may be added to the epoxy resin composition, as long as the effect of the invention is not deteriorated. For example, according to certain embodiments, component (C) is comprised of one or more amine curing agents (such as an aromatic amine curing agent or a non-aromatic amine curing agent) in addition to or instead of a diaminodiphenyl sulfone. In other embodiments, component (C) is comprised of at least one amine curing agent, such as an aromatic amine curing agent or aromatic polyamine curing agent, and at least one non-amine curing agent (i.e., a curing agent that does not contain any nitrogen atoms).

Examples of other curing agents include polyamides, aromatic amidoamines (e.g., aminobenzamides, aminobenzanilides, and aminobenzene sulfonamides), aromatic diamines (e.g., diamino diphenylmethane, and m-phenylenediamine), tertiary amines (e.g., N-N-dimethylaniline, N,N-dimethylbenzylamine, and 2,4,6-tris(dimethylaminomethyl) phenol), aminobenzoates (e.g., trimethylene glycol di-p-aminobenzoate and neopentyl glycol di-p-amino-benzoate), aliphatic amines (e.g., diethylenetriamine, triethylenetetramine, isophoronediamine, bis(aminomethyl) norbornane, bis(4-amino cyclohexyl)methane, dimer acid esters of polyethyleneimine), imidazole derivatives (e.g., 2-methylimidazole,1-benzyl-2-methylimidazole, 2-ethyl-4-methylimidazole), carboxylic acid anhydrides (e.g., methylhexa hydrophthalic anhydride), carboxylic acid hydrazides (e.g., adipic acid hydrazide, naphthaelencarboxylic acid hydrazide), tetramethylguanidine, carboxylic acid amides, polyphenol compounds, polysulfides and mercaptans, and Lewis acids and bases (e.g., boron trifluoride ethylamine and tris-(diethylaminomethyl) phenol), etc. For example, in embodiments where component (C) consists of diaminodiphenylsulfone, the epoxy resin composition may optionally additionally contain one or more of the above-mentioned curing agents. However, in other embodiments, the epoxy resin composition does not contain any curing agent other than the aforementioned component (C).

Furthermore, a latent curing agent can be also be used since it makes the storage stability of the epoxy resin composition excellent. A latent curing agent is a curing agent capable of exhibiting activity owing to a phase change or chemical change, etc. caused by certain stimulation such as heat or light. As the latent curing agent, an amine adduct latent curing agent, a microcapsule latent curing agent, as well as dicyandiamide derivatives, can be used. An amine adduct latent curing agent is a product having a high molecular weight that is insoluble in the epoxy resin composition at the storage temperature, obtained by reacting an active ingredient such as a compound having a primary, secondary or tertiary amine group or any of various imidazole derivatives with a compound capable of reacting with those compounds. A microcapsule latent curing agent is a product obtained by using a curing agent as a nucleus and covering the nucleus with a shell such as a high molecular weight substance, for example, an epoxy resin, polyurethane resin, polystyrene-based compound or polyimide, etc., or cyclodextrin, etc., to decrease the contact between the epoxy resin and the curing agent. A dicyandiamide derivative is obtained by combining dicyandiamide with any of various compounds. Also suitable for use as a latent curing agent is a product obtained by reaction with an epoxy resin and a product obtained by reaction with a vinyl compound or acrylic compound, etc.

Examples of commercially available products which are amine adduct latent curing agents include: “Amicure (registered Trademark)” PN-23, PN-H, PN-40, PN-50, PN-F, MY-24 and MY-H (manufactured by Ajinomoto Fine-Techno Co., Inc.), “Adeka Hardener (registered trademark)” EH-3293S, EH-3615S and EH-4070S (manufactured by Adeka

Corporation). Examples of commercially available products of suitable microcapsule latent curing agents include “Novacure (registered trademark)” HX-3721 and HX-3722 (manufactured by Asahi Kasei Chemicals Corporation. Examples of commercially available products of suitable dicyandiamide derivatives include DICY-7 and DICY-15 (manufactured by Japan Epoxy Resins Co., Ltd.). Any of the abovementioned curing agents can be used more than two in combination, as long as the effect of the invention is not deteriorated.

The amount of component (C) may be in the range of 10 to 60 PHR of total epoxy resin. If the amount is less than 10 PHR of total epoxy resin, the degree of cure may be insufficient at the cure temperature and the mechanical properties of FRC material obtained may be impaired. If the amount is greater than 60 PHR of total epoxy resin, the excess unreacted amine curing agent may adversely affect the mechanical properties of the FRC material obtained. In certain embodiments, the relative amounts of curing agent and epoxy resin in the epoxy resin composition are selected such that there is a significant molar excess of epoxy groups relative to active hydrogens from the amine curing agents. There are a total of four active hydrogens in a diaminodiphenyl sulfone curing agent. For example, components (A) and (B) may be present in amounts effective to provide a molar ratio of active hydrogens: epoxy groups from 0.4:1 to 1:1 (i.e., an AEW/EEW ratio of from 0.4 to 1.0, wherein AEW =amine equivalent weight and EEW =epoxy equivalent weight). Formulations having a molar ratio greater than 0.4:1 may have high heat resistance and increased properties, whereas formulations having a molar ratio lower than the upper limits of the aforementioned range may provide FRC material having high mechanical properties.

It has been discovered that the epoxy resin composition may be used with at least one curing catalyst to accelerate curing of the epoxy resin composition, as long as the effect of the invention is not deteriorated. Without wishing to be bound by theory, it is believed that curing catalyst utilized in the present embodiment may provide a high degree of cure (e.g., at least 85% or at least 90%) at a relatively low temperature (e.g., 177° C.) within a short period of time (e.g., two hours) is achieved.

In some embodiments, the epoxy resin composition may comprise component (D) wherein component (D) comprises at least one latent acid catalyst. A latent acid catalyst is a compound which essentially does not function as a catalyst (for curing of an epoxy resin composition) at temperatures in the vicinity of room temperature, but in the high temperature region in which the curing of the epoxy resin composition is carried out, normally 70-200° C., it either itself functions as an acid catalyst or produces chemical species which serve as an acid catalyst. In the case of the production of chemical species which serve as an acid catalyst, this may be brought about, for example, due to thermal reaction alone or by reaction with epoxy resin or amine curing agent present in the system.

In such embodiments, the latent acid catalyst is typically employed in a state completely dissolved in the epoxy resin composition. Consequently, component (D) may be soluble in component (A), component (B) or a mixture of constituent components (A) and (B). Here, “soluble in component (A) or in component (B)” means that when the latent acid catalyst and the component (A) or component (B) are mixed together at a specified compositional ratio and stirred, a uniform mixed liquid can be formed. Here, the uniform mixed liquid is formed with up to 5 PHR of the total epoxy resin between 60° C.-80° C.

Examples of constituent component (D) are onium salts of strong acids, such as quaternary ammonium salts, quaternary phosphonium salts, quaternary arsonium salts, tertiary sulphonium salts, tertiary selenonium salts, secondary iodonium salts, and diazonium salts of strong acids and the like. Strong acids may be generated either by the heating of these on their own or, for example, as disclosed in JP-A-54-50596, by the reaction of a diaryliodonium salt or triarylsulfonium salt and a reducing agent such as thiophenol, ascorbic acid or ferrocene, or alternatively, as disclosed in JP-A-56-76402, by the reaction of a diaryliodonium salt or triarylsulfonium salt and a copper chelate. The species of strong acid generated will be determined by the onium salt counter ion. As the counter ion, there is employed one which is substantially not nucleophilic and where its conjugate acid is a strong acid. Examples of suitable counter ions include perchlorate ion, tetrafluoroborate ion, sulfonate ion (p-toluenesulfonate ion, methanesulfonate ion, trifluoromethanesulfonate ion and the like), hexafluorophosphate ion, hexafluoroantimonate ion, tetrakis(pentafluorophenyl)borate ion and the like. Onium salts having these counter ions, while being ionic salts, are outstanding in their solubility in organic compounds and are suitable for use in the present embodiment.

When combined with aliphatic-epoxy resins, sulfonium salt complexes with hexafluoroantimonate and hexafluorophosphate counter ions have superior latency to strong Lewis acids including BF3/piperidine complexes, as disclosed in US Pat. Pub. No. 20030064228, due to their higher dissociation temperature. Superior latency is an advantageous characteristic from the viewpoint of the manufacturability of fiber-reinforced prepregs.

In one embodiment, the epoxy resin composition may contain at least one sulfonium salt represented by Formula (III);

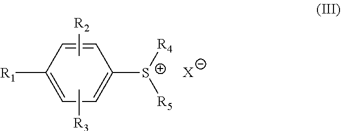

wherein R₁ represents a hydrogen atom, a hydroxyl group, an alkoxyl group, or a group represented by Formula (IV):

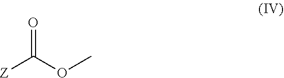

wherein Z represents an alkyl group, an alkoxyl group, a phenyl group or a phenoxy group, each of which may have one or more substituents. Each of R₂ and R₃ independently represents a hydrogen atom, a halogen atom, or an alkyl group. Each of R₄ and R₅ independently represents an alkyl group, an aralkyl group or an aryl group, each of which may have one or more substituents. X⁻ represents SbF₆⁻, PF₆⁻AsF₆⁻, or BF₄⁻.

While optional, the amount of component (D), if present, preferably may be between 0.1 and 5 PHR of the total amount of epoxy resin in the epoxy resin composition. If the amount is greater than 0.1 PHR, the temperature and time required to cure the material may be adjusted such that the time for cure is shortened, thereby reducing the overall time for manufacture. If the amount is less than 5 PHR, the resin cure cycle can be controlled and thereby reduce the risk of an uncontrolled exotherm causing the epoxy resin composition to become overheated.

Examples of component (D) include [4-(acetyloxy)phenyl]dimethylsulfonium, (OC-6-11)-hexafluoroantimonate(1-); (4-hydroxyphenyl)dimethylsulfonium, hexafluorophosphate(1-); (4-hydroxyphenyl)methyl[(2-methylphenyl)methyl]sulfonium, (OC-6-11)-hexafluoroantimonate(1-); (4-hydroxyphenyl)methyl(phenylmethyl)sulfonium, (OC-6-11)-hexafluoroantimonate(1-) and the like and combinations thereof.

In accordance with certain embodiments of the invention, the epoxy resin composition may further comprise a component (E) wherein the component (E) comprises at least one epoxy resin other than the types of epoxy resins which may be present as part of components (A) and (B), such as at least one glycidyl ether epoxy resin or glycidyl amine epoxy resin containing two or more epoxy functionalities per molecule, as long as the effect of the invention is not deteriorated. Such glycidyl ether epoxy resins and glycidyl amine epoxy resins are epoxy resins having chemical structures which do not correspond to Formula (I) or Formula (II) as set forth herein. Without wishing to be bound by theory, it is believed that the use of such epoxy resins in component (E) of the epoxy resin composition of the present invention may improve the cross linking, heat resistance, and processability.

These epoxy resins (epoxies) may be prepared from precursors such as amines (e.g., epoxy resins prepared using polyamines (e.g., diamines) and compounds containing at least one amine group and at least one hydroxyl group per molecule such as tetraglycidyl diaminodiphenyl methane, tetraglycidyl diaminodiphenylether, tetraglycidyl diaminodiphenylsulfone, tetraglycidyl diaminodiphenylamide, triglycidyl-p-aminophenol, triglycidyl-m-aminophenol, triglycidyl aminocresol and tetraglycidyl xylylenediamine and halogen-substituted products, alkynol-substituted products, hydrogenated products thereof and so on), phenols (e.g., bisphenol A epoxy resins, bisphenol F epoxy resins, bisphenol S epoxy resins, bisphenol R epoxy resins, phenol-novolac epoxy resins, cresol-novolac epoxy resins, resorcinol epoxy resins and triphenylmethane epoxy resins), dicyclopentadiene epoxy resins, naphthalene epoxy resins (epoxy resins containing only a single naphthalene moiety per molecule), epoxy resins having a biphenyl skeleton, isocyanate-modified epoxy resins, epoxy resins having a fluorene skeleton, and compounds obtained by epoxidation of carbon-carbon double bonds (e.g., alicyclic epoxy resins other than the alicyclic epoxy resins possibly used in component (B1)). It should be noted that the epoxy resins suitable for use in component (E) are not restricted to the examples above. Halogenated epoxy resins prepared by halogenating these epoxy resins can also be used. Furthermore, mixtures of two or more of these epoxy resins, and compounds having one epoxy group or monoepoxy compounds such as glycidylaniline, glycidyl toluidine or other glycidylamines (particularly glycidylaromatic amines) can be employed in the formulation of the epoxy resin composition.

Examples of commercially available products useful in component (E) include: amine-based epoxy resins such as YH434L (manufactured by Nippon Steel Chemical Co., Ltd.), S-722M and S-722 (manufactured by Synasia Fine Chemical Inc.), 3′3-TGDDE (manufactured by Toray Fine chemicals Co. Ltd.),“jER (registered trademark)” 604 (manufactured by Mitsubishi Chemical Corporation)”, TG3DAS (manufactured by Konishi Chemical Ind. Co., Ltd. or Mitsui Fine Chemicals, Inc.), “Sumiepoxy (registered trademark)” ELM434 and ELM100 (manufactured by Sumitomo Chemical Co., Ltd.), “Araldite (registered trademark)” MY9655T, MY0720, MY0721, MY0722, MY0500, MY0510, MY0600, and MY0610 (manufactured by Huntsman Advanced Materials), “jER (registered trademark)” 630 (manufactured by Mitsubishi Chemical Corporation), TETRAD-X and TETRAD-C (manufactured by Mitsubishi Gas Chemical Company, Inc.); bisphenol A epoxy resins such as “jER (registered trademark)” 825, 828, 834, 1001, 1002, 1003, 1003F, 1004, 1004AF, 1005F, 1006FS, 1007, 1009 and 1010 (manufactured by Mitsubishi Chemical Corporation), “Tactix (registered trademark)” 123 (manufactured by Huntsman Advanced Materials); brominated bisphenol A epoxy resins such as “jER (registered trademark)” 505, 5050, 5051, 5054 and 5057 (manufactured by Mitsubishi Chemical Corporation); hydrogenated bisphenol A epoxy resin such as ST5080, ST4000D, ST4100D, and ST5100 (manufactured by Nippon Steel Chemical Co., Ltd.); bisphenol F epoxy resins such as “jER (registered trademark)” 806, 807, 4002P, 4004P, 4007P, 4009P and 4010P (manufactured by Mitsubishi Chemical Corporation), and “Epotohto (registered trademark)” YDF2001 and YDF2004 (manufactured by Nippon Steel Chemical Co., Ltd.); tetramethyl-bisphenol F epoxy resins such as YSLV-80XY (manufactured by Nippon Steel Chemical Co., Ltd.); bisphenol S epoxy resins such as “Epiclon (registered trademark)” EXA-154 (manufactured by DIC Co., Ltd.); phenol-novolac epoxy resins such as “jER (registered trademark)” 152 and 154 (manufactured by Mitsubishi Chemical Corporation), and “Epiclon (registered trademark)” N-740, N-770, and N-775 (manufactured by DIC Co., Ltd.); cresol-novolac epoxy resins such as “Epiclon (registered trademark)” N-660, N-665, N-670, N-673, and N-695 (manufactured by DIC Co., Ltd.), and EOCN-1020, EOCN-102S and EOCN-104S (manufactured by Nippon Kayaku Co., Ltd,); resorcinol epoxy resins such as “Denacol (registered trademark)” EX-201 (manufactured by Nagase chemteX Corporation); naphthalene epoxy resins (containing a single naphthalene moiety per molecule) include HP4032 and HP4032D (manufactured by DIC Co., Ltd.), “Araldite (registered trademark)” MY 0816 (manufactured by Huntsman Advanced Materials);

triphenylmethane epoxy resins such as “jER (registered trademark)” 1032S50 (manufactured by Mitsubishi Chemical Corporation), “Tactix (registered trademark)” 742 (manufactured by Huntsman Advanced Materials) and EPPN-501H (which are manufactured by Nippon Kayaku Co., Ltd.); dicyclopentadiene epoxy resins include “Epiclon (registered trademark)” HP7200, HP7200L, HP7200H and HP7200HH (manufactured by DIC Co., Ltd.), “Tactix (registered trademark)” 556 (manufactured by Huntsman Advanced Materials), and XD-1000-1L and XD-1000-2L (manufactured by Nippon Kayaku Co., Ltd.); epoxy resins having a biphenyl skeleton such as “jER (registered trademark)” YX4000H, YX4000 and YL6616 (manufactured by Mitsubishi Chemical Corporation), and NC-3000 (manufactured by Nippon Kayaku Co., Ltd.); isocyanate-modified epoxy resins such as AER₄₁₅₂ (manufactured by Asahi Kasei Epoxy Co., Ltd.) and ACR₁₃₄₈ (manufactured by ADEKA Corporation) each of which has an oxazolidone ring; epoxy resins having a fluorene skeleton such as PG-100, CG-200 and EG-200 (manufactured by Osaka Gas Chemicals Co., Ltd and LME10169 (manufactured by Huntsman Advanced Materials); glycidylanilines such as GAN (manufactured by Nippon Kayaku Co., Ltd.), and glycidyl toluidines such as GOT (manufactured by Nippon Kayaku Co., Ltd.). Furthermore, more than one of these epoxies may be used in combination as component (E).

The amount of component (E) may be in the range of 0 to 70 PHR of total epoxy resin in the epoxy resin composition. In certain embodiments, the amount of component

(E) may be in the range of 10 to 60 PHR or 20 to 50 PHR of total epoxy resin. If the amount of component (E) is within the limits of the aforementioned ranges, heat resistance will be kept high and the handleability and processability can be easily adjusted.

In this invention, mixing or dissolving a thermoplastic resin into the above-mentioned epoxy resin composition may also be desirable to enhance the properties of the cured material. In general, a thermoplastic resin (polymer) having bonds selected from the group consisting of carbon-carbon bonds, amide bonds, imide bonds, ester bonds, ether bonds, carbonate bonds, urethane bonds, thioether bonds, sulfone bonds and/or carbonyl bonds in the main chain is used. Further, the thermoplastic resin can also have a partially crosslinked structure and may be crystalline or amorphous. In particular, it is suitable that at least one thermoplastic resin selected from the group consisting of polyamides, polycarbonates, polyacetals, polyphenylene oxides, polyphenylene sulfides, polyarylates, polyesters, polyamideimides, polyimides, polyetherimides, polyimides having a phenyltrimethylindane structure, polysulfones, polyethersulfones, polyetherketones, polyetheretherketones, polyaramids, polyethernitriles and polybenzimidazoles is mixed or dissolved into the epoxy resin composition.

In order to obtain good heat resistance, the glass transition temperature (Tg) of the thermoplastic resin is at least 150° C. or higher, or in some embodiments, the Tg of the thermoplastic resin is 170° C. or higher. If the glass transition temperature of thethermoplastic resin is lower than 150 ° C., the cured article obtained from the epoxy resin composition may be likely to be deformed by heat when it is used. In certain embodiment, a thermoplastic resin having hydroxyl groups, carboxyl groups, thiol groups, acid anhydride or the like as the end functional groups can be used, since it can react with a cationic polymerizable compound.

Specific examples of suitable thermoplastic resins are polyethersulfones and the polyethersulfone-polyether-ethersulfone copolymer oligomers as described in JP2004-506789 A; commercially available products of the polyetherimide type, etc. can also be used. An oligomer refers to a polymer with a relatively low molecular weight in which a finite number of approximately ten to approximately 100 monomer molecules are bonded to each other. Although the epoxy resin composition need not contain thermoplastic resin, in various embodiments of the invention the epoxy resin composition is comprised of at least 5 to as much as 30 PHR of thermoplastic resin based on the total amount of epoxy resin. This range is not particularly limited and can be adjusted as needed to change the viscosity for handleability and processability.

The epoxy resin composition comprising the abovementioned components (A)-(C) and, optionally, components (D) and/or (E) may have a dry Tg (glass transition temperature) of at least 230° C. and a wet Tg of at least 205° C. when fully cured. As used herein, the term “fully cured” epoxy resin means a cured epoxy resin where the degree of cure degree (DoC) is 90% or more after heating at 200° C. for 2 hours. The DoC of an epoxy resin composition can be determined by Differential Scanning calorimeter (DSC, such as a DSC manufactured by TA Instruments). The dry Tg refers to the glass transition temperature of a sample being tested without immersion and the wet Tg refers to the glass transition temperature of a sample being tested after immersing in boiling water for 24 hours. If the wet Tg is greater than 205° C., the FRC material will have high mechanical performance under hot/wet conditions and better thermal oxidative stability at higher temperatures.

In certain embodiments, the cure profile is not particularly limited, as long as the effect of the invention is not deteriorated. If a higher Tg is desired, the epoxy resin composition can be cured at higher temperature. For example, the epoxy resin composition may have a dry Tg of 240° C. and a wet Tg of 210° C. when the composition is cured at 210° C. for 2 hours. However, it is important to choose the right cure temperature as the flexural modulus of the epoxy resin composition may be impaired as Tg increases. The Tg of a cured epoxy resin can be determined by torsional Dynamic Mechanical Analyzer (ARES, manufactured by TA Instruments).

The epoxy resin composition comprising the abovementioned components (A)-(C) and, optionally, components (D) and/or (E) may have a room temperature flexural modulus of at least 3.5 GPa and a hot/wet flexural modulus of at least 2.3 GPa when fully cured. The room temperature flexural modulus refers to the sample being tested without immersion and the hot/wet flexural modulus refers to the sample being tested at 121° C. after immersing in boiling water for 24 hours. If the hot/wet flexural modulus is greater than 2.3 GPa, the FRC material obtained may have high compression strength. The flexural modulus of the cured epoxy resin can be determined by a 3-point bending test in accordance with ASTM D 7264 using an Instron Universal Testing Machine (manufactured by Instron).

The mechanical properties of the fiber-reinforced composite material are influenced by the various properties of the matrix (the product obtained by curing the epoxy resin composition). The elastic modulus of the matrix influences the fiber-direction compressive strength and tensile strength of the fiber-reinforced composite material, and the higher the value thereof the better. Consequently, the cured product of the epoxy resin composition of the present invention has a high elastic modulus, high heat resistance, and excellent elongation.

In the preparation of the epoxy resin composition, a kneader, planetary mixer, triple roll mill, twin screw extruder, and the like may advantageously be used. After the epoxy resins are placed in the equipment, the mixture is heated to a temperature in the range of from 80to 180° C. while being stirred so as to uniformly dissolve the epoxy resins. During this process, other components such as thermoplastic resin and/or inorganic particles may be added to the epoxy resins and kneaded with them. After this, the mixture is cooled down to a temperature of no more than 100° C. in some embodiments, no more than 80° C. in other embodiments, or no more than 60° C. in still other embodiments, while being stirred, followed by the addition of the component (C) comprising the curing agent(s) and catalyst(s) and kneading to disperse those components. This method may be used to provide an epoxy resin composition with excellent storage stability.

Next, the fiber-reinforced composite materials are described. By curing embodiments of the epoxy resin composition after impregnating reinforcing fibers with it, a fiber-reinforced composite material that contains, as its matrix resin, embodiments of the epoxy resin composition in the form of a cured product may be obtained.

There are no specific limitations or restrictions on the type of reinforcing fiber used in the present invention, and a wide range of fibers, including glass fiber, carbon fiber, graphite fiber, aramid fiber, boron fiber, alumina fiber and silicon carbide fiber, may be used. Carbon fiber may provide fiber-reinforced composite materials that are particularly lightweight and stiff. Carbon fibers with a tensile modulus of 180 to 800 GPa may be used, for example. If a carbon fiber with a high modulus of 180 to 800 GPa is combined with an epoxy resin composition of the present invention, a desirable balance of stiffness, strength and impact resistance may be achieved in the fiber-reinforced composite material.

There are no specific limitations or restrictions on the form of reinforcing fiber, and fibers with diverse forms may be used, including, for instance, long fibers (drawn in one direction), tow, fabrics, mats, knits, braids, and short fibers (chopped into lengths of less than 10 mm). Here, long fibers mean single fibers or fiber bundles that are effectively continuous for at least 10 mm. Short fibers, on the other hand, are fiber bundles that have been chopped into lengths of less than 10 mm. Fiber configurations in which reinforcing fiber bundles have been aligned in the same direction may be suitable for applications where a high specific strength and specific modulus are required.

The fiber-reinforced composite materials may be manufactured using methods such as the prepreg lamination and molding method, resin transfer molding method, resin film infusion method, hand lay-up method, sheet molding compound method, filament winding method and pultrusion method, though no specific limitations or restrictions apply in this respect.

Resin transfer molding is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

Prepreg lamination and molding is a method in which a prepreg or prepregs, produced by impregnating a reinforcing fiber base material with a thermosetting resin composition, is/are formed and/or laminated, followed by the curing of the resin through the application of heat and pressure to the formed and/or laminated prepreg/prepregs to obtain a fiber-reinforced composite material.

Filament winding is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

Pultrusion is a method in which reinforcing fibers are continuously passed through an impregnating tank filled with a liquid thermosetting resin composition to impregnate them with the thermosetting resin composition, followed by a squeeze die and heating die for molding and curing, by continuously drawing them using a tensile machine. Since this method offers the advantage of continuously molding fiber-reinforced composite materials, it is used for the manufacture of fiber-reinforced composite materials for fishing rods, rods, pipes, sheets, antennas, architectural structures, and so on.

Of these methods, the prepreg lamination and molding method may be used to give excellent stiffness and strength to the fiber-reinforced composite materials obtained.

Prepregs may contain embodiments of the epoxy resin composition and reinforcing fibers. Such prepregs may be obtained by impregnating a reinforcing fiber base material with the epoxy resin composition of the present invention. Impregnation methods include the wet method and hot melt method (dry method).

The wet method is a method in which reinforcing fibers are first immersed in a solution of an epoxy resin composition, created by dissolving the epoxy resin composition in a solvent, such as methyl ethyl ketone or methanol, and retrieved, followed by the removal of the solvent through evaporation via an oven, etc. to impregnate reinforcing fibers with the epoxy resin composition. The hot-melt method may be implemented by impregnating reinforcing fibers directly with an epoxy resin composition, made fluid by heating in advance, or by first coating a piece or pieces of release paper or the like with an epoxy resin composition for use as resin film and then placing a film over one or either side of reinforcing fibers as configured into a flat shape, followed by the application of heat and pressure to impregnate the reinforcing fibers with the epoxy resin composition. The hot-melt method may give a prepreg having virtually no residual solvent in it.

The reinforcing fiber cross-sectional density of a prepreg may be 50 to 350 g/m². If the cross-sectional density is at least 50 g/m², there may be a need to laminate a small number of prepregs to secure the predetermined thickness when molding a fiber-reinforced composite material and this may simplify lamination work. If, on the other hand, the cross-sectional density is no more than 350 g/m², the drapability of the prepreg may be good. The reinforcing fiber mass fraction of a prepreg may be 50 to 90 mass % in some embodiments, 55 to 85 mass % in other embodiments or even 60 to 80 mass % in still other embodiments. If the reinforcing fiber mass fraction is at least 50 mass %, there generally is sufficient fiber content, and this may provide the advantage of a fiber-reinforced composite material in terms of its excellent specific strength and specific modulus, as well as preventing the fiber-reinforced composite material from generating too much heat during the curing time. If the reinforcing fiber mass fraction is no more than 90 mass %, impregnation with the resin may be satisfactory, decreasing a risk of a large number of voids forming in the fiber-reinforced composite material.

To apply heat and pressure under the prepreg lamination and molding method, the press molding method, autoclave molding method, bagging molding method, wrapping tape method, internal pressure molding method, or the like may be used as appropriate.

Autoclave molding is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range. Due to the exceptionally high Tg of the cured epoxy resin composition of the present invention, it may be advantageous to carry out curing of the prepreg at a relatively high temperature (e.g., a temperature of at least 180° C. or at least 200° C.). For example, the molding temperature may be from 200° C. to 275° C. Alternatively, the prepreg may be molded at a somewhat lower temperature (e.g., 90° C. to 200° C.), demolded, and then post-cured after being removed from the mold at a higher temperature (e.g., 200° C. to 275° C.).

The wrapping tape method is a method in which prepregs are wrapped around a mandrel or some other cored bar to form a tubular fiber-reinforced composite material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The molding temperature may be in the 80 to 300° C. range.

The internal pressure forming method is a method in which a preform obtained by wrapping prepregs around a thermoplastic resin tube or some other internal pressure applicator is set inside a metal mold, followed by the introduction of high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range. It is also operable to partially cure the epoxy resin composition of the present invention to form a B-stage product and subsequently cured the B stage product completely at a later time.

The fiber-reinforced composite materials that contain cured epoxy resin compositions obtained from epoxy resin compositions of the present invention and reinforcing fibers are advantageously used in sports applications, general industrial applications, and aeronautic and space applications. Concrete sports applications in which these materials are advantageously used include golf shafts, fishing rods, tennis or badminton rackets, hockey sticks and ski poles. Concrete general industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

With respect to mechanical properties of carbon fiber-reinforced composite materials, although the tensile strength has been greatly increased as the tensile strength of carbon fibers increases, increase of the compressive strength is small even if high tensile-strength fibers are used instead of standard tensile-strength fibers. Accordingly, flexural strength is important for practical uses, which is determined by the compressive strength because it is smaller than the tensile strength. Therefore, the compressive strength is very important for uses of structural materials on which compressive or flexural stress is applied. Particularly, the compressive strength is an extremely important property for use as a primary structure material. Further, in the case of an aircraft, since there are many bolt holes, open hole compressive strength becomes important.

Further, because mechanical properties, particularly the compressive strength, are greatly decreased under hot/wet conditions, open hole compressive strength under hot/wet conditions becomes very important. When considering the open hole compressive strength at 180° C. under hot/wet conditions, both the glass transition temperature and the modulus of the cured matrix material are essential because OHC is a resin dominant property.

### EXAMPLES

### Materials

The following commercial products were employed in the preparation of the epoxy resin compositions of the Examples.

### Carbon Fibers

Torayca T700G-12K-31E Unidirectional Carbon fiber (registered trademark, manufactured by Toray Industries Inc.) having a fiber count of 12,000, tensile strength of 4900 MPa, tensile modulus of 240 GPa, and tensile elongation of 1.8%.

Csomponent [A]:
NC-7000L (registered trademark, manufactured by Nippon Kayaku) having an epoxide equivalent weight (EEW) of 227 g/eq.
Epiclon HP-4770 (registered trademark, manufactured by DIC) having an epoxide equivalent weight (EEW) of 205 g/eq.

### Component [B]:

Celloxide Cel-2021P (registered trademark, manufactured by Daicel), having an epoxide equivalent weight (EEW) of 131 g/eq.
Araldite CY 184 (registered trademark, manufactured by Huntsman Advanced Materials) having an epoxide equivalent weight (EEW) of 171 g/eq.
XU 19127 (registered trademark, manufactured by Olin) having an epoxide equivalent weight (EEW) of 82 g/eq.

### Component [C]:

Aradur 9664-1 (registered trademark, manufactured by Huntsman Advanced Materials).
Aradur 9791-1 (registered trademark, manufactured by Huntsman Advanced Materials).

### Component [D]:

San-Aid SI-110 and SI-150 (registered trademark, manufactured by the Sanshin Chemical Industry).

### Component [E]:

Araldite MY 816 (registered trademark, manufactured by Huntsman Advanced Materials) having an epoxide equivalent weight (EEW) of 148 g/eq.
Araldite MY 721 (registered trademark, manufactured by Huntsman Advanced Materials) having an epoxide equivalent weight (EEW) of 112 g/eq.
Araldite MY 0510 (registered trademark, manufactured by Huntsman Advanced Materials), having an epoxide equivalent weight (EEW) of 101 g/eq.
DEN440 (registered trademark, manufactured by Olin), having an epoxide equivalent weight (EEW) of 186 g/eq.

### Thermoplastic Resin

Polyethersulfone, “Virantage (registered trademark)” VW10700RFP polyethersulfone (manufactured by Solvay Advanced Polymers) having a number average molecular weight of 21,000 g/mol.

### Methods

1. Resin Mixing

A mixture was created by dissolving prescribed amounts of all the components other than the curing agent and a curing catalyst (optional) in a mixer, and then prescribed amounts of the curing agent were mixed into the mixture along with amounts of the curing accelerator (optional) to obtain the epoxy resin composition.
2. Resin Plate Preparation

The epoxy resin composition was cured and molded by the following method described in this section. After mixing, the epoxy resin composition prepared in (1) was injected into a mold set for a thickness of 2 mm using a 2 mm-thick “Teflon (registered trademark)” spacer. Then, the epoxy resin composition was heated at a rate of 1.7° C./min from room temperature to 180° C. and then kept for 2 hours at 180° C. to obtain 2 mm-thick cured epoxy resin composition plates. Then the cured resin plate was taken out of the mold and further post-cured in a conventional oven at 210° C. for two hours at a rate of 1.7° C./min to obtain the final cured plate.
3. Glass Transition Temperature (Tg) of Cured Resin

In other embodiments of the present invention, the epoxy resin composition may have a certain Tg (glass transition temperature). The Tg may be determined using the following method. A specimen measuring 12.5 mm×50 mm is cut from a cured epoxy resin composition obtained in method (2). The specimen is then subjected to measurement of Tg in 1.0 Hz Torsion Mode using a dynamic viscoelasticity measuring device (ARES, manufactured by TA Instruments) by heating it over the temperature range of 50° C. to 330° C. at a rate of 5° C./min in accordance with SACMA SRM 18R-94. Tg was determined by finding the intersection between the tangent line of the glassy region and the tangent line of the transition region from the glassy region to the rubbery region on the temperature-storage elasticity modulus G′ curve, and the temperature at that intersection was considered to be the glass transition temperature (Tg), commonly referred to as G′ onset Tg.
4. 3-pt Flexural Test

In other embodiments of the present invention, the cured epoxy resin composition may have certain flexural properties. Flexural properties were measured in accordance with the following procedure. A specimen measuring 10 mm×50 mm is cut from the cured epoxy resin composition obtained in method (2). Then, the specimen is processed in a 3-point bend flexural test in accordance with ASTM D7264 using an Instron Universal Testing Machine (manufactured by Instron). In the case of room temperature properties, the test specimens are not immersed and are tested at room temperature to obtain the RTD (room temperature dry) flexural properties of the cured epoxy resin composition. In the case of hot/wet properties, the specimens are immersed under boiling water for 24 hours. Then the specimens are placed in the pre-heated test chamber at 121° C. and held for 3 minutes prior to starting the test. The ETW (elevated temperature wet) flexural properties of the cured epoxy resin composition can be obtained from this.
5. Water Absorption

In other embodiments of the present invention, the cured epoxy resin composition may have a certain water absorption. Water absorption is determined using the following procedure. A specimen measuring 10 mm×50 mm is cut from the cured epoxy resin composition obtained in (2). The specimen is immersed under boiling water for 24 hours.

The water absorption can be calculated from the following formula:

$$water absorption ( wt \% ) = \frac{{W}_{i} - {W}_{B}}{{W}_{B}} \times 100$$

where:Wᵢ=the initial weight of resin before immersion
   W_{B}=the initial weight of resin after immersion
6. Production of Fiber-Reinforced Composite Material

A prepreg comprising a reinforcing fiber impregnated with the epoxy resin composition was prepared. The epoxy resin composition obtained in method (1) was applied onto release paper using a knife coater to produce two sheets of resin film. Next, the aforementioned two sheets of fabricated resin film were overlaid on both sides of unidirectional carbon fibers (T700S-12K-31E) with a density of 1.8 g/cm² in the form of a sheet and the epoxy resin composition was impregnated using rollers to produce a prepreg with a carbon fiber areal weight of 190 g/m² and a resin content of 35wt %.
7. Open Hole Compression Strength (OHC) for FRC

In some embodiments, an FRC laminate comprising the epoxy resin composition was prepared to test Open Hole Compression (OHC) strength. The prepreg was cut into 350 mm×350 mm samples. After layering 16 sheets of the fabric prepreg samples to produce a [+45, 0, −45, 90]₂ₛ configuration laminate, vacuum bagging was carried out, and the laminate was cured at a rate of 1.7° C./min from room temperature to 180° C. and then kept for two hours under pressure of 0.59 MPa using an autoclave to obtain a quasi-isotropic FRC material. Then the cured FRC material was taken out of the autoclave and further post cured in a conventional oven at 210° C. for two hours at the rate of 1.7° C./min to obtain the final FRC material. This test specimen was then subjected to open hole compression testing as prescribed in ASTM-D6484 using an Instron Universal Testing Machine. Measurement was taken at the elevated temperatures of 121° C. and 180° C. wet (ETW) after immersing at 72° C. water for 2 weeks and at room temperature dry (RTD).
8. Tensile Strength (TS) for FRC

In some embodiments, the FRC laminate comprising the epoxy resin composition was prepared to test 0° tensile strength. The prepreg was cut into 300 mm×300 mm samples. After laying 12 sheets of the fabric prepreg samples to produce a [0°]₁₂ configuration laminate and cured as described in method (7). This test specimen was then subjected to tensile testing as prescribed in ASTM-D3039 using an Instron Universal Testing Machine. Measurement was taken at room temperature dry (RTD). The following methods were used to prepare and measure the epoxy resin composition, the prepreg and the FRC material for each example.

### Discussion of Results

The various amounts of the components used for each example are stated in Tables 1 and 2. The epoxy resin compositions and the properties shown in the tables were produced as described in the methods section.

Examples 1 to 11 provided good results compared with comparative examples 1-4 in terms of processability. The absence of poly-naphthalene-based epoxy resin in comparative examples 5-7 resulted a large amount of water absorption and lower hot/wet flexural modulus, particularly when tested above 120° C. Epoxy resin compositions containing a large amount of alicyclic epoxy resin or divinylarene dioxide epoxy resin as in comparative examples 5-6 showed significantly lower flexural elongation, wet Tg, and hot/wet flexural modulus. In contrast to these comparative examples, the examples comprising the abovementioned components of the present invention provided higher flexural modulus, flexural strength, and better water absorption while maintaining high glass transition temperatures and processability.

The FRC materials were prepared by the abovementioned methods for working examples 1-11. These epoxy resin composition, in addition to providing low water absorption and high heat resistance when cured, have significantly higher open hole compression strength when cured, particularly under hot/wet conditions as compared with comparative examples. In addition to the open hole compression strength improvement, the tensile strength was also improved. This is believed to be due to the poly-naphthalene-based epoxy resin providing high Tg and high toughness without increasing the crosslink density. It is known that lower crosslink density provides higher tensile strength. The higher tensile strength was anticipated for the working examples comprising epoxy resin compositions in accordance with the invention as the crosslink density of the invention was lower than the state-of-the-art epoxy resin.

TABLE 1

| | | Unit | CE-1 | CE-2 | CE-3 | CE-4 | CE-5 | CE-6 | CE-7 | CE-8 | CE-9 |
|---|---|---|---|---|---|---|---|---|---|---|---|
| Component A | NC-7000L/H | PHR | | 50 | | | | | 35 | 35 | 35 |
| | HP-4770 | | 50 | | 30 | | | | | | |
| Component B | Cel2021P/CY 179 | PHR | | | | 40 | | | 20 | | |
| | YDH184/CY 184 | | | | | | | | | 20 | |
| | Dicyclopentadiene diepoxide | | | | | | | | | | 20 |
| | XU19127 | | | | | | 50 | 40 | | | |
| Component E | MY 816 | PHR | | | | | | | | | |
| | MY 721 | | 50 | 50 | | 60 | 50 | | 45 | 45 | 45 |
| | MY 0510 | | | | 70 | | | | | | |
| | DEN440 | | | | | | | 60 | | | |
| Component C | Aradur 9664-1 | AEW/EEW | | 1.0 | 1.0 | 0.6 | 1.0 | 1.0 | 1.0 | 0.7 | 0.7 |
| | Aradur 9719-1 | AEW/EEW | 1.0 | | | | | | | | |
| Component D | San-Aid SI-150 | PHR | | | | 1.0 | | | 1.0 | 1.0 | 1.0 |
| Thermoplastic | Virantage VW-10700RFP | | 10 | 10 | 15 | 15 | 15 | 15 | 15 | 15 | 15 |
| Tg | Dry | ° C. | 220 | 240 | 235 | 209 | 230 | 239 | 200 | 216 | 195 |
| | Wet* | ° C. | 200 | 220 | 233 | 191 | 200 | 225 | 185 | 200 | — |
| | Strength @RTD | MPa | 160 | 163 | 161 | 155 | 120 | 148 | — | 143 | — |
| | Modulus @RTD | GPa | 3.9 | 3.7 | 3.6 | 3.9 | 4.0 | 3.6 | — | 4.0 | — |
| Flexural Test | Elongation @RTD | mm | 4.6 | 3.8 | 5.6 | 3.3 | 2.0 | 4.0 | — | 3.5 | — |
| | Modulus @121° C.-ETW* | GPa | 2.4 | 2.2 | 2.2 | 1.5 | 1.9 | 2.1 | — | 2.2 | — |
| | Water absorption | wt % | 3.8 | 3.5 | 4.0 | 3.9 | 4.5 | 3.5 | — | 3.5 | — |
| OHC Strength | RTD | MPa | 317 | 310 | 307 | — | 321 | 304 | — | 321 | — |
| | ETW** @121° C. | MPa | 235 | 226 | 218 | — | 210 | 223 | — | 227 | — |
| | ETW** @180° C. | MPa | 165 | 178 | 171 | — | — | 175 | — | 179 | — |
| 0° TS | RTD | MPa | 2190 | 2196 | 2192 | — | — | 2166 | — | 2156 | — |

*ETW modulus and wet Tg: Conditioned at 98° C. for 24 hours boil water immersion
**ETW OHC: Conditioned at 72° C. for 2 weeks water immersion

TABLE 2

| | | Unit | Ex.1 | Ex.2 | Ex.3 | Ex.4 | Ex.5 | Ex.6 | Ex.7 | Ex.8 | Ex.9 | Ex.10 | Ex.11 |
|---|---|---|---|---|---|---|---|---|---|---|---|---|---|
| Component A | NC-7000L/H | PHR | 60 | 60 | | 60 | | 35 | 35 | 35 | 35 | 35 | 35 |
| | HP-4770 | | | | 30 | | 30 | | | | | | |
| Component B | Cel2021P/CY 179 | PHR | 15 | | | | | | 5 | 5 | | | |
| | YDH184/CY 184 | | | 15 | 15 | | | | | | 5 | 5 | |
| | Dicyclopentadiene diepoxide | | | | | | | | | | | | 5 |
| | XU19127 | | | | | 40 | 40 | 5 | | | | | |
| Component E | MY 816 | PHR | | | | | | 10 | 10 | 10 | 10 | 10 | 10 |
| | MY 721 | | 20 | 20 | 55 | | 30 | 25 | 25 | 25 | 25 | 25 | 25 |
| | MY 0510 | | | | | | | 25 | 25 | 25 | 25 | 25 | 25 |
| | DEN440 | | | | | | | | | | | | |
| Component C | Aradur 9664-1 (4,4′-DDS) | AEW/EEW | 0.8 | 0.8 | 0.9 | 1.0 | 0.6 | 1.0 | 0.8 | 0.8 | 0.8 | 0.7 | 0.7 |
| | Aradur 9719-1 (3,3′-DDS) | AEW/EEW | | | | | | | | | | 0.1 | 0.1 |
| Component D | San-Aid SI-150 | PHR | 0.5 | | | | 1.0 | | 0.5 | | | | |
| Thermoplastic | Virantage VW-10700RFP | | 15 | 15 | 15 | 15 | 15 | 15 | 15 | 15 | 15 | 15 | 15 |
| Epoxy Resin Properties | | | | | | | | | | | | | |
| Tg | Dry | ° C. | 233 | 230 | 230 | 238 | 230 | 235 | 228 | 225 | 228 | 226 | 220 |
| | Wet* | ° C. | 210 | 208 | 205 | 220 | 207 | 220 | 208 | 210 | 214 | 208 | 205 |
| | Strength @RTD | MPa | 160 | 160 | 159 | 168 | 182 | 173 | 162 | 165 | 163 | 179 | 150 |
| | Modulus@RTD | GPa | 3.9 | 3.8 | 4.0 | 3.8 | 3.8 | 3.9 | 3.9 | 3.9 | 3.9 | 3.9 | 3.8 |
| Flexural Test | Elongation @RTD | mm | 4.2 | 4.1 | 4.0 | 4.8 | 4.6 | 4.7 | 4.2 | 4.0 | 4.6 | 4.7 | 5.4 |
| | Modulus @121° C.-ETW* | GPa | 2.3 | 2.3 | 2.2 | 2.4 | 2.5 | 2.5 | 2.3 | 2.3 | 2.3 | 2.3 | 2.3 |
| | Water absorption | wt % | 3.2 | 3.2 | 3.5 | 3.1 | 3.0 | 3.1 | 3.2 | 3.0 | 2.8 | 2.9 | 3.0 |
| CFRC Properties (normalized to vf 60%) | | | | | | | | | | | | | |
| | RTD | MPa | 317 | 314 | 320 | 314 | 315 | 317 | 317 | 317 | 317 | 316 | 314 |
| OHC Strength | ETW** @121° C. | MPa | 230 | 230 | 227 | 234 | 238 | 237 | 231 | 229 | 231 | 229 | 228 |
| | ETW** @180° C. | MPa | 181 | 181 | 179 | 184 | 188 | 187 | 182 | 180 | 182 | 170 | 170 |
| 0° TS | RTD | MPa | 2190 | 2190 | 2188 | 2206 | 2110 | 2216 | 2194 | 2200 | 2196 | 2228 | 2170 |

*ETW modulu and wet Tg: Conditioned at 98° C. for 24 hours boil water immersion
**ETW OHC: Conditioned at 72° C. for 2 weeks water immersion

1. An epoxy resin composition for a fiber-reinforced composite material comprising component (A), component (B), and component (C), wherein the epoxy resin composition when cured has a wet Tg of at least 205° C. and a hot/wet flexural modulus of at least 2.3 GPa, and wherein:
component (A) comprises at least one poly-naphthalene-based epoxy resin;
component (B) comprises at least one liquid epoxy resin having a viscosity of less than 1 Pa·s at 25° C.; and
component (C) comprises at least one amine curing agent.

2. The epoxy resin composition according to claim 1, wherein component (B) comprises at least one of (B1) at least one alicyclic epoxy resin represented by Formula (I) which is present in an amount of up to 15 PHR of total epoxy resin in the epoxy resin composition, or (B2) at least one divinylarene dioxide represented by Formula (II) which is present in an amount of up to 40 PHR of total epoxy resin in the epoxy resin composition: 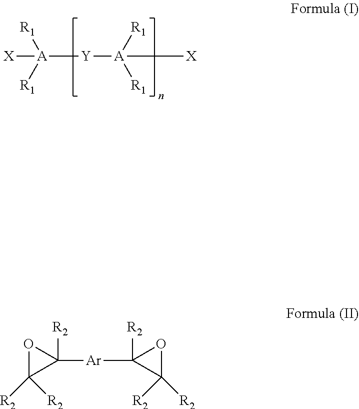
wherein n is an integer of 0 or 1; each A is a cycloaliphatic group independently selected from the group consisting of cycloalkyl groups and cycloalkenyl groups having 4 to 8 carbon atoms; each X is independently selected from the group consisting of a hydrogen atom and an oxygen atom attached to adjacent carbon atoms of a cycloaliphatic group to form an epoxy group; Y, if present, is selected from the group consisting of a direct bond, —SO₂—, —C(=O)O—,—C(═O)—, —O—, —C(=O)NH—, C₁ to C₆ alkyl groups, C₁ to C₆ alkoxyl groups, cycloalkyl groups, and aryloxyl groups, wherein these groups are optionally employed individually or different groups are optionally employed in combination as Y; each R₁ is independently selected from the group consisting of a hydrogen atom, a glycidyl group, a glycidyl ether group, a glycidyl ester group, and a cycloalkyl group having 4 to 7 carbon atoms directly attached at least one of the A groups; Ar is selected from the group consisting of aryl groups; and each R₂ is independently selected from the group consisting of a hydrogen atom, an alkyl group, a cycloalkyl group, an aryl group, and an aralkyl group, subject to the proviso that the alicyclic epoxy resin represented by Formula (I) contains at least two epoxy groups per molecule.

3. The epoxy resin composition according to claim 2, wherein component (B) comprises at least one alicyclic epoxy resin represented by Formula (I).

4. The epoxy resin composition according to claim 2, wherein component (B) comprises at least one divinylarene dioxide represented by Formula (II).

5. The epoxy resin composition according to claim 4, wherein component (B) comprises one or more divinylarene dioxides selected from the group consisting of divinylbenzene dioxides, divinylnaphthalene dioxides, divinylbiphenyl dioxides, divinyldiphenylether dioxides, and mixtures thereof.

6. The epoxy resin composition according to claim 2, wherein component (B1) and component (B2) are present in amounts effective to provide a ratio of component (B1): component (B2) of from 0:40 to 15:0 PHR of total epoxy resin.

7. The epoxy resin composition according to claim 2, wherein component (B1) is present in an amount of from 3 to 15 PHR of total epoxy resin.

8. The epoxy resin composition according to claim 2, wherein component (B2) is present in an amount of from 3 to 40 PHR of total epoxy resin.

9. The epoxy resin composition according to claim 1, wherein component (A) comprises at least one poly-naphthalene-based epoxy resin with an EEW greater than 150 g/eq which is present in an amount of 20 to 60 PHR of total epoxy resin.

10. The epoxy resin composition according to claim 1, wherein component (C) comprises at least one aromatic polyamine.

11. The epoxy resin composition according to claim 9, wherein component (C) consists of at least one diaminodiphenyl sulfone which is present in an amount which provides an AEW/EEW ratio of from 0.4 to 1.0.

12. The epoxy resin composition according to claim 1, wherein the epoxy resin composition further comprises component (D) and component (E), wherein:
component (D) comprises at least one latent acid catalyst; and
component (E) comprises at least one glycidyl ether epoxy resin or glycidyl amine epoxy resin containing at least two epoxy groups per molecule which is not an alicyclic epoxy resin according to Formula (I) or a divinylarene dioxide according to Formula (II).

13. The epoxy resin composition according to claim 12, wherein component (D) comprises at least one onium salt catalyst.

14. The epoxy resin composition according to claim 12, wherein component (D) comprises at least one onium salt catalyst represented by Formula (III): 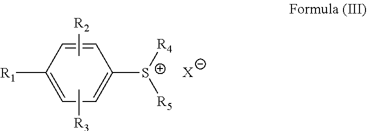
wherein R₁ represents a hydrogen atom, a hydroxyl group, an alkoxyl group, or a group represented by Formula (IV): 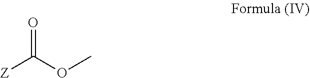
wherein Z represents an alkyl group, an alkoxyl group, a phenyl group or a phenoxy group, all of which may have one or more substituents, each of R₂ and R₃ independently represents a hydrogen atom, a halogen atom, or an alkyl group, each of R₄ and R₅ independently represents an alkyl group, an aralkyl group or an aryl group, each of which may have one or more substituents, and X⁻ represents SbF₆⁻, PF₆⁻AsF₆⁻, or BF₄⁻.

15. The epoxy resin composition according to claim 12, wherein the epoxy resin composition comprises an amount of component (D) which is 0.1 to 5 PHR of total epoxy resin in the epoxy resin composition.

16. The epoxy resin composition according to claim 12, wherein the epoxy resin composition comprises an amount of component (E) which is at most 70 PHR of total epoxy resin in the epoxy resin composition.

17. The epoxy resin composition according to claim 1, additionally comprising at least one thermoplastic resin.

18. The epoxy resin composition according to claim 17 wherein the at least one thermoplastic resin comprises a polyethersulfone.

19. The epoxy resin composition according to claim 1, wherein the epoxy resin composition when cured has a water absorption less than 3.3 wt %.

20. A prepreg comprising carbon fibers impregnated with an epoxy resin composition in accordance with claim 1.

21. A carbon fiber-reinforced composite material obtained by curing a prepreg in accordance with claim 20.

22. A carbon fiber-reinforced composite material comprising a cured resin product obtained by curing a mixture comprised of an epoxy resin composition in accordance with claim 1 and carbon fibers.
